(19) United States
(12) Patent Application Publication
(10) Pub. No.: US 2026/0064642 A1
(43) Pub. Date: Mar. 5, 2026

(54) Machine Learning Based Auto-Reconciliation By Generating Remediation Records As Necessary Based On Time-Aware Models

(71) Applicant: Oracle International Corporation, Redwood Shores, CA (US)

(72) Inventors: John D. Clark, JR., Pepperell, MA (US); Pathanjali Malay, Leawood, KS (US); Tim Gaumont, Mesa, AZ (US)

(73) Assignee: Oracle International Corporation, Redwood Shores, CA (US)

(21) Appl. No.: 19/097,320

(22) Filed: Apr. 1, 2025

Related U.S. Application Data
(60) Provisional application No. 63/690,641, filed on Sep. 4, 2024.

(51) Int. Cl. G06F 16/215; G06N 20/00

(52) U.S. Cl. CPC G06F 16/215; G06N 20/00

(57) ABSTRACT

Techniques for remediating discrepancies between datasets by applying a trained, time-aware machine learning model to determine whether or not to auto-reconcile discrepancies are disclosed. To train a time-aware machine learning model, a system generates a training dataset of event records that records event attributes, including a time associated with the event and a magnitude associated with the event. The dataset of event records includes a first set of event records that are candidates for reconciliation and a second set of event records against which the first set would be reconciled. The time-aware machine learning model generates a recommendation for auto-reconciliation of dataset discrepancies based on discrepancy data and auto-reconciliation data. The discrepancy data and auto-reconciliation data are based on (a) a current time period or a time period corresponding to a current candidate remediation record and (b) time periods preceding the current time period.

### BENEFIT CLAIMS; RELATED APPLICATIONS; INCORPORATION BY REFERENCE

This application claims the benefit of U.S. Provisional Patent Application 63/690,641, filed Sep. 4, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to machine learning based auto-reconciliation. In particular, the present disclosure relates to selectively implementing auto-reconciliation of discrepancies among sets of records using a time-aware machine learning model.

### BACKGROUND

With vast amounts of data stored in different locations and maintained by different entities, organizations are incapable of manually identifying every discrepancy among different sets of records that record the same sets of events. For example, an organization may rely on one external entity to maintain records of events associated with one type of event. The organization may rely on another entity to maintain records of events of another type. The organization may maintain its own records of the different types of events.

When attempting to verify datasets and/or determine a current state of data, goods, and/or currency recorded in different datasets, organizations may identify various types of discrepancies. One dataset may include an event record that another dataset omits. Two datasets may include records for the same event, but they may be recorded with different attribute values, such as a time of the event, a category of the event, or a magnitude associated with the event. Errors may arise from user entry of data or from miscalculations in an automated application. Different sources of datasets may vary in reliability. Accordingly, a discrepancy between a primary dataset and a secondary dataset may be treated differently from a discrepancy between the primary dataset and a tertiary dataset.

Organizations need to identify an accurate state of data stored in datasets to generate forecasts and allocate resources based on the data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A and 2B illustrate an example set of operations for remediating dataset discrepancies based on machine learning recommendations in accordance with one or more embodiments;

FIG. 3 illustrates an example set of operations for training a machine learning model;

FIGS. 4A-4D illustrate an example embodiment; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DATASET RECONCILIATION ARCHITECTURE
3. DATASET RECONCILIATION BASED ON MACHINE LEARNING RECOMMENDATIONS
4. TRAINING A MACHINE LEARNING MODEL TO GENERATE RECOMMENDATION SCORES
5. EXAMPLE EMBODIMENT
6. COMPUTER NETWORKS AND CLOUD NETWORKS
7. HARDWARE OVERVIEW
8. MISCELLANEOUS; EXTENSIONS

### 1. General Overview

One or more embodiments remediate discrepancies between datasets by applying a trained machine learning model to generate recommendations for whether to auto-reconcile discrepancies or reconcile discrepancies manually. Auto-reconciliation is a process where a computer compares two or more datasets of event records and generates remediation records to reconcile the two or more datasets without intervening human input. In one or more embodiments, the system provides discrepancy data for one or more discrepancies between two or more datasets to a machine learning model to generate a recommendation whether or not to auto-reconcile, without human input, the discrepancies. Based on the recommendation, a system may either auto-reconcile a discrepancies or notify a user that human-reconciliation is recommended.

One or more embodiments train a machine learning model by generating a training dataset of event records that record event attributes, including a time associated with the event and a magnitude associated with the event. The event records include at least two independent sets of event records. For example, if a system detects a discrepancy between two datasets of event records, the system may modify one of the datasets to include a remediation record. According to another example, a system determines whether to perform an auto-reconciliation of a single dataset based on data included within the dataset. For example, a system may determine that an auto-reconciliation may be automatically performed based on identifying a particular type of discrepancy within the dataset, such as a mis-categorization of a set of event records. The remediation record is assigned a magnitude value that reconciles the attribute values of the two sets of event records without modifying existing records. For example, the system may calculate the cumulative value of the same attribute in the two datasets of event records to determine the cumulative values are not the same. The system may generate a remediation record based on the discrepancy. The system adds the remediation record to one of the datasets. The remediation record is assigned an attribute value to cause the two cumulative values for the same attribute in the two datasets to be the same. The remediation record may further be assigned a name or category that identifies the cause, type, or reason for the discrepancy.

One or more embodiments apply a time-aware machine learning model to generate a recommendation for auto-reconciliation of dataset discrepancies based on discrepancy data and auto-reconciliation data. The discrepancy data and auto-reconciliation data are based on (a) a current time period or a time period corresponding to a current candidate remediation record and (b) time periods preceding the current time period. For example, a system may train a transformer-based machine learning model on a sequence of datasets and corresponding reconciliations. A set of training data may include examples of a system rule to manually reconcile a set of event records after three consecutive periods of auto-reconciliation. As another example, the training data may embody a rule to recommend manual reconciliation based on the number of periods in which a discrepancy is based on a certain type of error, such as a user error or an error made by an external system. The transformer-based machine learning model “learns,” via training, the rule for manual reconciliation. In other words, the neurons of the transformer-based machine learning model are encoded with values that embody the rule for time-based manual reconciliation. Accordingly, if the transformer-based machine learning model identifies a threshold number of previous consecutive sets of event records have been auto-reconciled, the transformer-based machine learning model generates an auto-reconciliation recommendation score for the next set of event records that corresponds to a recommendation not to auto-reconcile the next set of event records.

One or more embodiments generate input vectors from sets of event records. The system generates multiple input vectors representing multiple different reconciliation periods for an event record dataset. The system provides the input vectors to the time-aware machine learning model to generate an auto-reconciliation recommendation value. The system compares the auto-reconciliation recommendation value to a threshold. If the auto-reconciliation recommendation value meets the threshold, the system performs auto-reconciliation of the set of event records without obtaining human input to initiate the reconciliation. Performing auto-reconciliation may include inserting a new remediation record into the set of event records. The new remediation record is given a value that reconciles the sets of event records to each other. For example, the time-aware machine learning model may generate a recommendation value between 0 and 1. The system may perform auto-reconciliation based on an output value between 0.8 and 1. The system may generate a notification to a user to request a confirmation of auto-reconciliation for a recommendation value between 0.7 and 0.79. The system may refrain from performing auto-reconciliation or generating a notification to confirm auto-reconciliation for recommendation values between 0 and 0.69. In some embodiments, the system generates a notification that manual reconciliation is recommended when the time-aware machine learning model generates a recommendation value between 0 and 0.69.

One or more embodiments receive new datasets to be incorporated into an existing event record management platform. New datasets may correspond to newly acquired companies or new clients, for example. The new datasets include sets of event data. For example, when an event record management platform obtains new data associated with a new client, the platform may upload multiple years' worth of event record data maintained by the client. The system pre-processes the event record data. Pre-processing the event record data includes modifying content and generating records of a type to be ingested by the trained, time-aware machine learning model. The system converts the pre-processed event data into vector data. The system applies the vector data to the trained time-aware machine learning model to generate the auto-reconciliation recommendation scores to determine whether or not to auto-reconcile the new event record data with existing datasets.

One or more embodiments described in this Specification and/or recited in the claims may not be included in this General Overview section.

### 2. Dataset Reconciliation Architecture

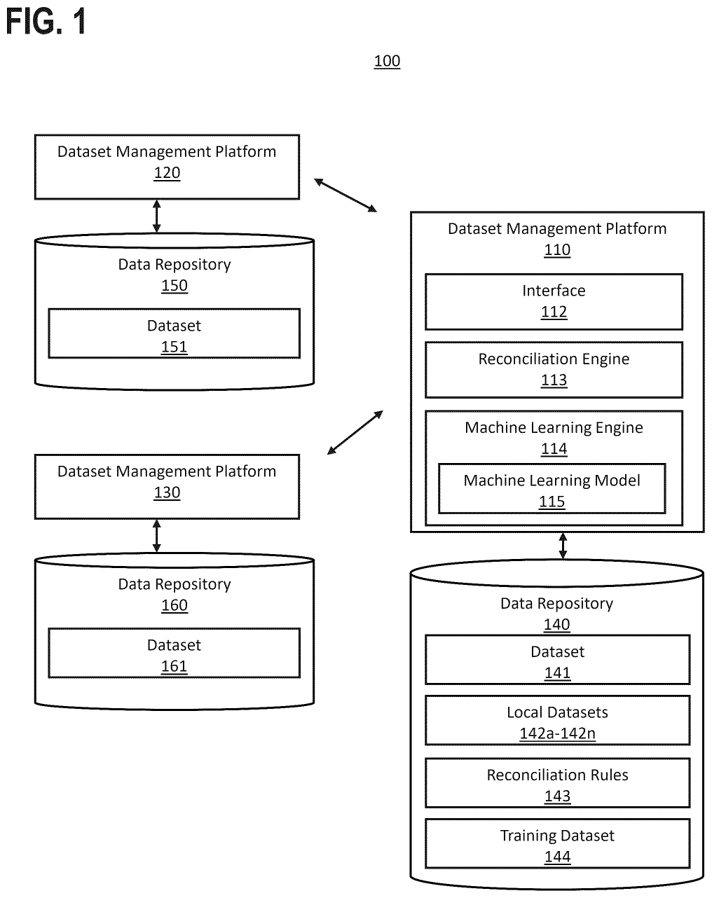

FIG. 1 illustrates a system 100 in accordance with one or more embodiments. As illustrated in FIG. 1, system 100 includes dataset management platforms 110, 120, and 130 and data repositories 140, 150, and 160. The dataset management platforms 110, 120, and 130 manage access to respective datasets 141, 151, and 161. The dataset management platform 110 includes a reconciliation engine 113 to identify discrepancies among datasets (e.g., datasets 141, 151, 161, and 142a-142n) and to generate remediation records to reconcile the datasets. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

In one or more embodiments, a data repository 140 is any type of storage unit and/or device (e.g., a file system, database, collection of tables, or any other storage mechanism) for storing data. Furthermore, a data repository 140 may include multiple different storage units and/or devices. The multiple different storage units and/or devices may or may not be of the same type or located at the same physical site. Furthermore, a data repository 140 may be implemented or executed on the same computing system as the dataset management platform 110. Additionally, or alternatively, a data repository 140 may be implemented or executed on a computing system separate from the dataset management platform 110. The data repository 140 may be communicatively coupled to the dataset management platform 110 via a direct connection or via a network.

Information describing datasets 141 and 142a-142n, reconciliation rules 143, and training dataset 144 may be implemented across any components within the system 100. However, this information is illustrated within the data repository 140 for purposes of clarity and explanation.

The dataset management platform 110 includes an interface 112. The interface 112 allows a user to interact with the dataset management platform 110 to view datasets, perform reconciliations, and manage the automated performance of auto-reconciliations.

In one or more embodiments, interface 112 refers to hardware and/or software configured to facilitate communications between a user and the dataset management platform 110. Interface 112 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 112 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 112 is specified in one or more other languages, such as Java, C, or C++.

The dataset management platform 110 manages local datasets 141 and 142a-142n in the data repository 140. The dataset management platform 120 manages the remote dataset 151 in the data repository 150. The dataset management platform 130 manages the remote dataset 161 in the data repository 160. The dataset management platforms 110, 120, and 130 may be implemented as applications running on computers, such as servers, to receive requests to access and modify data stored in datasets. Dataset management platform 110 may download the remote dataset 151 at defined intervals from the dataset management platform 120 to add to the local datasets 142a-142n.

Datasets 141, 142a-142n, 151, and 161 may comprise event records. The event records may record the transfer of goods, currency, and/or data between entities. According to one example, the dataset management platform 110 is associated with a company. The dataset management platforms 120 and 130 are associated with financial institutions. In this example, the dataset 141 may represent a general ledger recording transactions between the company and other entities, including the financial institutions. The datasets 151 and 161 represent transactions between the financial institutions and the company. According to another example, the event records represent the transfer of goods between locations. In this example, the dataset management platform 110 may be associated with a central warehouse, the dataset management platform 120 may be associated with a manufacturing center, and the dataset management platform 130 may be associated with a retail location. The dataset 141 represents the transfer of goods between the central warehouse and other entities, including the manufacturing center and the retail location. The dataset 151 represents the transfer of goods from the manufacturing center to the central warehouse. The dataset 161 represents the transfer of goods between the retail location and the central warehouse.

According to yet another example, dataset management platform 110 is associated with a data storage center such as central server in a cloud computing environment. Dataset management platforms 120 and 130 represent client servers. In this example, dataset 141 represents the transfer to data objects from the central server to remote servers, including the client servers. Dataset 151 represents a record of transfers of data objects from the central server to the client server represented by dataset management platform 120. Dataset 161 represents a record of transfers of data objects from the central server to the client server represented by dataset management platform 130.

The reconciliation engine 113 identifies discrepancies among datasets and reconciles the datasets by remediating discrepancies. Remediating discrepancies may be performed automatically, without human intervention, or manually, by a human. Examples of discrepancies between datasets include the following: different cumulative values for an attribute across sets of event records; a different attribute value for two event records that correspond to the same event in two datasets; incorrect record identifiers, such as names or categories; incorrect dates associated with an event in event records; records that appear in different reconciliation periods in datasets maintained by different entities; and records that appear in one dataset and are absent from another dataset but which should be present in both datasets (or absent from both datasets).

The reconciliation engine 113 generates a remediation record to add to a dataset to reconcile the dataset to another dataset. The remediation record includes at least one attribute. The reconciliation engine 113 assigns a value to the attribute to result in reconciliation of datasets. The system assigns a name, ID, or category to the remediation record to describe the discrepancy. For example, the cumulative value of an attribute across the event records in one dataset may be 100. The cumulative value of the attribute across the event records in another dataset may be 97. The reconciliation engine 113 may generate a remediation record with an attribute value of 3. The reconciliation engine 113 may add the remediation record to the latter dataset to bring the cumulative value of the attribute to 100. The reconciliation engine 113 may further assign a name to the remediation record of “mis-entered record” or “record included in next reporting period”. Alternatively, the reconciliation engine 113 may generate a remediation record with an attribute value of −3. The reconciliation engine 113 may add the remediation record to the former dataset to bring the cumulative value for the attribute to 97.

The machine learning engine 114 trains a machine learning model 115 to generate a recommendation score for whether to auto-reconcile or manually reconcile datasets. In one or more embodiments, the machine learning engine employs a machine learning algorithm to train the machine learning model 115. The machine learning algorithm is an algorithm that can be iterated to train a target model ƒ that best maps a set of input variables to an output variable, using a set of training data, including the training dataset 144. The training data includes datasets and associated labels. The datasets are associated with input variables for the target model ƒ. The associated labels are associated with the output variable of the target model ƒ. The training data may be updated based on, for example, feedback on the predictions by the target model ƒ and accuracy of the current target model ƒ. Updated training data is fed back into the machine learning algorithm, which in turn updates the target model ƒ.

The reconciliation engine 113 reconciles datasets based on reconciliation rules 143. Rules include conditions for when to manually reconcile datasets, when to auto-reconcile datasets, and how to generate a remediation record. Conditions may be based on attributes of event records, attribute values, dates associated with event records, entities associated with event records (such as individuals, organizations, or companies), a time associated with the event record, and patterns associated with an attribute over multiple defined periods of time.

The training dataset 144 includes training records that implement the reconciliation rules 143. For example, if a reconciliation rule specifies that a reconciliation should be performed manually if a discrepancy between a cumulative attribute value between datasets exceeds 100, the training dataset 144 include sufficient training records to train the machine learning model 115 to implement the rule.

In an operation, the dataset management platform 110 may download datasets 151 and 161 from remote systems to store them among the datasets 142a-142n managed by the dataset management platform 110. For example, in an inventory management system, the dataset management platform 110 may regularly download inventory data from remote locations. The dataset management platform 110 may store the datasets downloaded from remote locations separately from datasets that record inventory transactions internally.

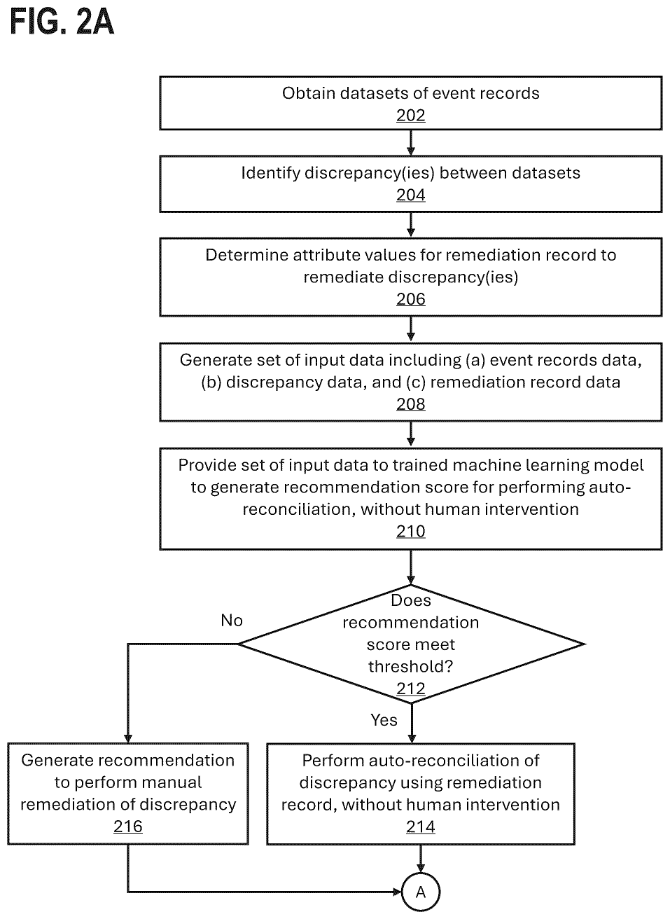

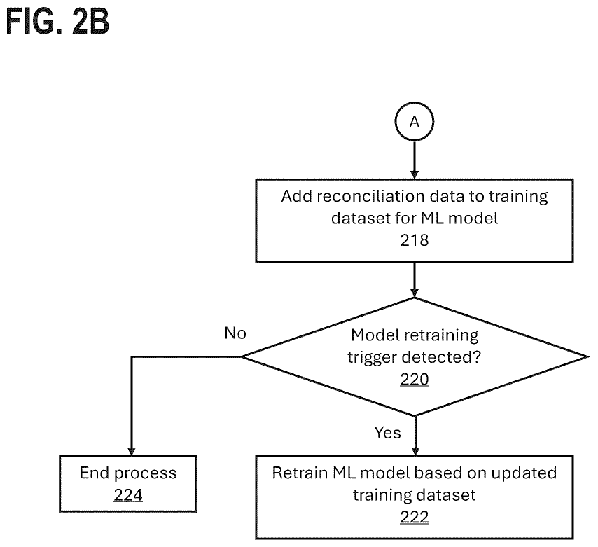

In one or more embodiments, a dataset management platform 110 refers to hardware and/or software configured to perform operations described herein for ensuring the validity of datasets by reconciling datasets generated from different entities with each other. Examples of operations for reconciling datasets based on machine learning recommendations are described below with reference to FIGS. 2A and 2B.

In an embodiment, the dataset management platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a server, and a mainframe.

### 3. Dataset Reconciliation Based on Machine Learning Recommendations

FIGS. 2A and 2B illustrate an example set of operations for remediating discrepancies in datasets based on machine learning recommendations in accordance with one or more embodiments. One or more operations illustrated in FIGS. 2A and 2B may be modified, rearranged, or omitted. Accordingly, the particular sequence of operations illustrated in FIGS. 2A and 2B should not be construed as limiting the scope of one or more embodiments.

Referring to FIG. 2A, a system obtains event record datasets (Operation 202). In some embodiments, event record datasets describe events, such as the transfer of goods, services, or money. In some embodiments, events include electronic transfers of data, objects, and files. An event record dataset includes a set of records. The records store attribute values for record attributes. Examples of attributes include a date and/or time that an event occurred and a magnitude associated with an event. In an embodiment where an event record is a transaction record, the record may include an amount of money and/or a quantity of goods or services transferred. Event records may include additional attributes, such as an event ID and a type of event. Event record datasets may be stored digitally as tables in computer memory or databases.

As an example, a system may present a graphical user interface (GUI) to a user to manage transaction data. A user may select a primary account to be reconciled with a secondary account or set of records. The system may present a set of transactions associated with the primary account to be reconciled. A user may select one or more additional sets of transaction data to reconcile the account. The additional sets of transaction data may include additional accounts or other financial records, such as bank records, invoices, and credit statements. A user may select a primary account and a secondary account. In an embodiment where the event records are financial records, the user may select a company account record and a bank statement. The user may reconcile the company account record to the bank statement. Additionally, or alternatively, a user may select a set of invoices to reconcile with a set of inventory data for a set of goods. Records may include the transfer of goods between locations without reference to any exchange of money. For example, an inventory management platform may store records for warehouses. The set of event records may record the transfer of items between warehouses. In yet another embodiment, the event records represent the transfer of data among nodes in a system, such as between a host database and client databases, or among servers in a system. The system may reconcile data that has been requested by clients with data that is actually stored in client devices.

The system identifies one or more discrepancies between datasets of event records (Operation 204). Discrepancies include differences between records present in the different datasets and differences between attribute values for the different datasets of event records. For example, a first set of event records may include ten records corresponding to ten different events. A second set of event records may include eight records corresponding to eight different events. The system identifies the two missing events in the second set of event records as a discrepancy between the datasets.

In one example, a host database server may store a record of 100 transactions with a client server. The client server may store a record of only 98 transactions with the host database server. As another example, an inventory management system may store a record of a transfer of 100 items with a warehouse. However, a warehouse inventory may store a record of receiving only 98 items. According to another example, a general ledger may include records of 20 transactions with a bank during a month. The bank statement may include records of 22 transactions.

Additionally, or alternatively, discrepancies may include differences in attribute values for the same event between different records in different datasets. For example, a host database server may store a record specifying a transfer of a 100 Gbyte data file to a client. The client server may store a record of receiving a file of only 100 Mbytes. As another example, an inventory management system may store a record of a transfer of a container that includes three items. However, a warehouse inventory may store a record of a container that contained only 2 items. In another example, a company's general ledger maintained in an accounting application may include a record of a transaction for 550 USD. A bank statement may include a record of the transaction for 505 USD. In addition to magnitude values, discrepancies may include differences in record identifiers or classifiers. For example, a record in one dataset may correspond to a particular value “10” on a particular date. A record in another dataset may specify the same value and the same date. However, the record ID in one dataset may be “Product A” and the record ID in the other dataset may be “Product B.” The system identifies the different record ID's for the same event as a discrepancy.

In one or more embodiments, discrepancies arise among datasets to be reconciled based on user error, system (e.g., computer) errors, and timing discrepancies. For example, a host may record an event as having occurred when a data transaction was initiated. A client may record the event as having occurred when the data transaction was completed. As another example, a bank may record a transaction when a payment card is used. A company may record the same transaction in its accounting application when an employee turns in a receipt. As another example, a central warehouse may record goods as sent to a storefront when they leave the warehouse. However, the goods may not arrive at the storefront until days later. Accordingly, the storefront's inventory may not match the warehouse's inventory record from one time period to another.

Discrepancies may include differences in an event date, event classification, record descriptors, and a magnitude associated with the event (e.g., an amount of data stored, transmitted, or received, a number of goods stored, transmitted or receive, or an amount of a financial commodity stored, transmitted, or received).

In one embodiment, a system determines attribute values for a remediation record to remediate discrepancies (Operation 206). Attribute values may be temporal value (e.g., a date), categorical values, or magnitude values. For example, a discrepancy may include records of the same event that have different dates. Another discrepancy may include records of the same event that have different names, identifiers, or categories. Yet another discrepancy may include a difference in magnitude, such as a difference in an amount of data, goods, or currency transmitted or stored.

Determining the attribute value may include determining a difference between a cumulative value for the attribute in one set of event records and the cumulative value for the attribute in another set of event records. For example, company's local ledger may record a cumulative value for deposits to a bank in a month. A bank's statement may record a different cumulative value for deposits in the same month. An attribute value of the remediation record may correspond to the difference in cumulative values. In some embodiments, the system may identify multiple different attribute values for multiple different remediation records. For example, an inventory management system may record two shipments from a central facility to a remote facility at the end of an inventory tracking period. If the inventory tracking period ends before the shipments arrive at the remote facility, the inventory management system of the central facility may record a different inventory quantity than the inventory management system at the remote facility. The system may identify two attribute values-one for each shipment—for two different remediation records to reconcile the inventories.

Remediation records reconcile values among datasets without changing values in existing records. Instead, the remediation records are assigned a value to cause the two or more datasets to be reconciled to each other. The remediation records may further be assigned categories to reflect the type of remediation. A remediation record generated to represent an event recorded in different reporting periods in two different sets of event data may be assigned one classification. A remediation record generated to represent a user data entry error may be assigned another classification. A remediation record generated to represent a third-party error may be assigned yet another classification. Remediation records generated to reconcile magnitudes of attributes may be assigned a particular classification. Remediation records generated to reconcile different event ID's or categorizations may be assigned another classification

The system generates a set of input data to provide to a machine-learning model for generating a recommendation score (Operation 208). The recommendation score represents a strength of a recommendation whether to perform an auto-reconciliation or a manual reconciliation. The set of input data includes event records data. The event records data may include event records from multiple sources in a particular reporting period such as event records for a month. For example, event records data may include event records stored by a company for a month and event records stored by a third party for the same month. The event records of the two entities may correspond, at least in part, to the same set of events.

The input data may further include discrepancy data. Discrepancy data may include a type of an identified discrepancy, a magnitude of an identified discrepancy, and a time associated with the discrepancy. The input data may further include remediation record data. The remediation record data may include, for example, numbers of remediation records generated to reconcile two datasets, types of remediation records, and magnitudes of attributes specified in the remediation records. Discrepancy data and/or remediation record data may further include contextual data that is not presented in the event records data. For example, discrepancy data and/or remediation data may include an identity of a user associated with a discrepancy (such as a user that entered data incorrectly or a user associated with missing event records). Contextual data may include applications associated with generating and storing particular event records. Contextual data may include entities associated with transmitting currency, goods, and/or data specified in event records. Additional examples of contextual data include a cumulative attribute value, either currently or at the end of a reporting period, a number of event records in the dataset within a reporting period, and entities associated with event records.

For example, if a dataset is a financial record, the contextual data may include an outstanding balance of an account, an ending balance at the end of a monthly reporting period, and a level of account activity based on the number of transactions in the reporting period. Additionally, the system may determine how an account balance compares with a historical balance, such as the historical average over the previous 12 months. A system may assign a “risk” value to an account based on transactions received from countries that employ less rigorous accounting controls.

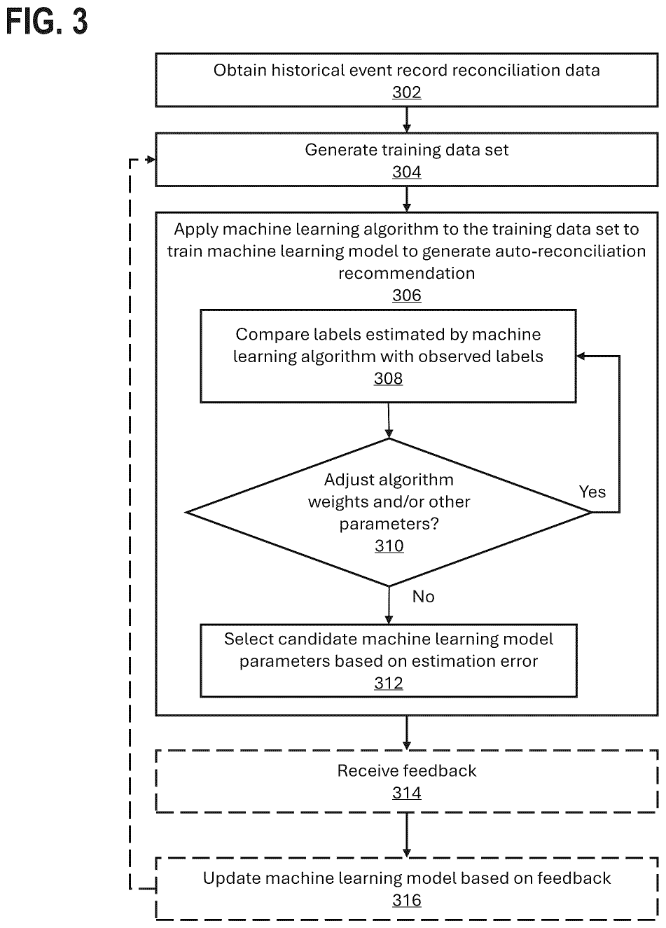

The system provides the set of input data to a trained machine learning model to generate a recommendation score (Operation 210). As noted above, the recommendation score represents a strength of a recommendation whether to perform an auto-reconciliation or a manual reconciliation. The machine learning model may be a time-aware model that generates the recommendation score based on time-series data, including event records associated with multiple different reconciliation periods. The model may be, for example, a model trained as discussed in FIG. 3 to generate a recommendation score along a gradient scale. For example, the model may generate a recommendation score in decimal increments between, and including, 0 and 1. The recommendation score represents a recommendation strength that datasets should be auto-reconciled. For example, a score of 0-0.6 may correspond to a recommendation to not auto-reconcile datasets. A score of 0.61-0.8 may correspond to a weak recommendation to auto-reconcile datasets. A score of 0.81-1 may correspond to a strong recommendation to auto-reconcile datasets.

The system determines if the recommendation score generated by the time-aware model meets a threshold value (Operation 212). For example, a threshold value may be set at 0.9. If the recommendation score generated by the time-aware model is 0.9 or higher, the system determines a set of event records is a candidate for auto-reconciliation. A system may set a threshold based on any number of considerations, including a type of data represented in the event records and a number of consecutive preceding reconciliation periods in which an auto-reconciliation process was performed. An organization may set the threshold at a value to manage the amount of manual control it wants to retain over dataset reconciliations.

If the recommendation score does not meet the threshold, the system does not perform auto-reconciliation (Operation 208). The system may generate a notification to a user indicating that a user should perform a manual reconciliation of the transaction data. For example, a system may present a primary dataset of event records in a GUI. A user may select a secondary dataset to reconcile to the primary dataset. The system identifies discrepancies between the primary dataset and the secondary dataset. The system applies dataset data (such as event records from the primary and secondary datasets) to a trained machine learning model to generate an auto-reconciliation recommendation score. If the system determines the score does not meet a threshold, the system may generate a message in the GUI recommending that the user perform a manual reconciliation of the primary dataset and the secondary dataset. The system may further highlight one or more discrepancies among the primary dataset and the secondary dataset.

In one or more embodiments, the system generates a remediation record to add to a dataset. The system may present the remediation record to a user in the GUI with a recommendation to perform a manual reconciliation of two datasets using the remediation record. For example, if the difference between a cumulative value for an attribute in a primary dataset and a secondary dataset is “10”, the system may generate a remediation record with a value of “10” for the attribute. The system may present the remediation record to the user with a recommendation to add the remediation record to the primary dataset. In one embodiment, the system refrains from recommending a remediation record if a recommendation score falls below a threshold. For example, if a recommendation score is less than 0.5/1.0, the system may (a) recommend manual reconciliation of a pair of datasets and (b) refrain from recommending a remediation record. If the recommendation score is between 0.5 and 0.75, the system may (a) recommend manual reconciliation of the pair of datasets and (b) present a recommended remediation record. If the recommendation score is between 0.76 and 1, the system may perform auto-reconciliation of the pair of datasets.

If the recommendation score does meet the threshold, the system performs auto-reconciliation of the datasets without human intervention (Operation 214). Auto-reconciliation includes inserting a remediation record into at least one dataset of a pair of datasets. The system may populate the remediation record with attribute values identified in Operation 206 for reconciling two datasets. For example, the system may select a transaction amount, transaction category, and transaction description to automatically reconcile a set of transaction records being reconciled to a bank statement.

Reconciling datasets may include generating multiple remediation records. For example, one discrepancy between datasets may be the result of a human incorrectly entering a value in a record in a primary dataset. Another discrepancy may be the result of a delay in an event being recorded in a secondary dataset. The system may reconcile the primary dataset to the secondary dataset by generating a first remediation record to include in the primary dataset and a second remediation record to include in the secondary dataset. Alternatively, a system may permit the addition of remediation records to one dataset while preventing the addition of remediation records to the other dataset. For example, when reconciling an internally maintained dataset with externally maintained datasets, a system may permit the modification of the internally maintained dataset and prevent the modification of externally maintained datasets.

The system may generate a notification or report that the datasets have been auto-reconciled. According to one example, a user selects two datasets for reconciliation. A primary dataset may be presented in a GUI. The user may select a secondary dataset to reconcile with the primary dataset. Based on the user selection of the secondary dataset, the system may perform, without human intervention, Operations 204, 206, 208, 210, 212, and 214. The system may present the results of the auto-reconciliation in the GUI in response to the user selection of the secondary dataset and the determination in Operation 212 that a recommendation score meets a threshold for performing auto-reconciliation.

Referring to FIG. 2B, based on performing the reconciliation, the system updates the training dataset for the machine learning model with reconciliation data (Operation 218). For example, if a user manually performs a reconciliation, the system generates a training dataset record that includes attributes of the pair of datasets that were reconciled and a label indicating the reconciliation was manual. The training dataset record may further include the recommendation score that was previously generated by the machine learning model. According to one example, the system generates a notification to a user recommending manual reconciliation of datasets based on a recommendation score being less than a threshold. If the user selects auto-reconciliation, the training dataset record indicates the auto-reconciliation was selected based on the corresponding dataset attributes. Conversely, a user may provide feedback that an auto-reconciliation should have been performed manually instead. The system generates a training dataset record specifying a manual reconciliation recommendation for the corresponding set of dataset attributes.

The system determines if a model retraining trigger is detected (Operation 220). A model retraining trigger may include a specified number of reconciliation operations. For example, the system may retrain the machine learning model after performing ten reconciliation operations.

The model retraining trigger may be based on a percentage of correct recommendations or auto-reconciliations. For example, the system may trigger retraining when a recommendation accuracy (i.e., the recommendation to manually reconcile datasets or auto-reconcile datasets) falls below 80% over a defined number of recording periods. When the system recommends manual reconciliation and the user selects auto-reconciliation, the system identifies the recommendation as an incorrect recommendation. Similarly, when the system recommends auto-reconciliation and the user indicates the datasets should have been manually reconciled, the system identifies the recommendation as incorrect.

If the system determines the model retraining trigger was detected, the system retrains the machine learning model based on an updated training dataset that includes newly generated training dataset records from recently performed reconciliation operations (Operation 222). The system may retrain the machine learning model by re-adjusting model weights and parameters. In some examples, the system stores a set of feedback records prior to retraining the model. Operations for training and re-training the machine learning model are discussed in further detail in FIG. 3.

Conventional systems may rely on complex sets of rules to determine (a) how to reconcile two datasets to each other and (b) whether or not to allow a computer to auto-reconcile datasets without human intervention. For example, rules may proscribe or prescribe an auto-reconciliation of datasets based on any combination of the following features: (a) types of attributes in event records, (b) magnitudes of the attributes, (c) particular dates and date ranges, (d) particular users associated with event records, (e) patterns of previous manual and auto-reconciliations, and (f) sources of datasets. For example, one set of rules may specify:
(i) Auto-reconcile a discrepancy between datasets from source A and source B
(ii) unless the discrepancy exceeds 100 units in one reporting period, or
(iii) unless the discrepancy exceeds 200 units over three reporting periods, or
(iv) unless auto-reconciliation was performed in three consecutive preceding time periods, or
(v) unless a user associated with the discrepancy is the same in three reporting periods within the same year.

Another set of rules for the same entity may specify:
(i) Auto-reconcile a discrepancy between attribute L, attribute M, or attribute N only in datasets from source A and source C
(ii) unless the discrepancy exceeds 200 units in one reporting period, or
(iii) unless the discrepancy involves an event record of Category D, AND the discrepancy exceeds 20 units, or
(iv) unless a user associated with the discrepancy is User Y, or
(v) unless the discrepancy is an error-type discrepancy in the dataset from source C.

Applying complex sets of rules to extensive datasets to determine if allowing a computer to auto-reconcile datasets without human intervention is a time-consuming and error-prone process. Entities may maintain different sets of rules for different dataset sources. For example, one dataset source may be considered a reliable source, whereas another may be considered unreliable. The system may maintain different rules for whether or not to apply auto-reconciliation to reconcile datasets from the different sources. As another example, datasets to be reconciled may include different numbers of attributes. Dataset A may include values for 10 attributes, while Dataset B may include values for 20 attributes. A system maintains rules to specify the subset of attributes, among the attributes that may be in common between Dataset A and Dataset B, that should be analyzed for discrepancies and reconciliation. Furthermore, attributes may be recorded differently in different datasets. Dataset A may record an attribute as XYZ, whereas Dataset B may record the same attribute as ABC, and Dataset C may record the same attribute as LMN. A system may maintain rules to map attribute names from different datasets to each other for possible reconciliation of attribute values among different datasets.

While FIGS. 2A and 2B describe an embodiment in which two datasets are reconciled, embodiments encompass determining whether to auto-reconcile a single dataset without identifying discrepancies with other datasets. For example, a system may identify certain types of discrepancies, such as mis-categorizations and values that the system identifies as errors without comparing the values to other datasets. A system may apply a machine learning model to the discrepancy data of the dataset to determine whether to auto-reconcile the dataset. Additionally, a system may determine whether to auto-reconcile a dataset based on contextual data associated with the dataset, such as a cumulative attribute value for the dataset, a comparison of the cumulative attribute value with a historical average, a number of event records in the dataset, and entities associated with event records in the dataset.

Embodiments improve the performance of data verification among datasets maintained in, and used by, one or more computing systems by applying a machine learning model to dataset data to generate recommendations for whether or not to auto-reconcile datasets. If the recommendation exceeds a threshold, a computer may auto-reconcile datasets without human intervention. If the recommendation falls below an upper threshold and above a lower threshold, the system may generate a user prompt to confirm auto-reconciliation. If the recommendation falls below a lower threshold, the system may generate a prompt recommending manual reconciliation of datasets. The machine learning model is trained on a training dataset including sets of event records that implement complex sets of rules. As a result, the machine learning model learns, via training, the complex sets of rules. Upon implementing the model, a user may provide further feedback regarding whether the model's recommendations are correct or incorrect. The system may then re-train the model based on the feedback to learn new rules to apply and to refine previous learning.

For example, a system may apply a machine learning model to a single dataset to determine whether to auto-reconcile the dataset. The dataset may be a financial record. The system may learn from training that if the ending balance of the account represented in the financial record exceeds the average ending balance of the previous 12 months by more than 20%, the model should generate a recommendation score corresponding to manual reconciliation rather than auto-reconciliation. The model may learn through training that if a discrepancy corresponds to a transposition error, the model should generate a recommendation value that corresponds to a recommendation to auto-reconcile the account. The model may learn via training that if any error value is associated with a transaction originating from a particular country, the system should generate a recommendation value corresponding to manual reconciliation.

Embodiments improve the performance of computing operations that rely on the datasets by providing reconciled datasets to applications requesting event records that correspond to certain events or a range of events. For example, an application may request a set of records describing every data transfer from a database on a particular day. The system may return a set of records that includes (a) event records describing data transfers from the database and (b) at least one remediation record describing an identified discrepancy between a dataset maintain in the database and a dataset maintained in an external server that requested data from the database.

### 4. Training a Machine Learning Model to Generate Recommendation Scores

FIG. 3 illustrates an example set of operations for training a time-aware machine learning model to generate recommendation scores for whether to perform auto-reconciliation or manual reconciliation in accordance with one or more embodiments. One or more operations illustrated in FIG. 3 may be modified, rearranged, or omitted. Accordingly, the sequence of operations illustrated in FIG. 3 should not be construed as limiting the scope of one or more embodiments.

A system obtains historical dataset reconciliation data (Operation 302). Obtaining the historical dataset reconciliation data may include obtaining historical datasets reflecting reconciliations between a primary dataset and one or more secondary datasets. According to one or more embodiments, obtaining the historical dataset reconciliation data includes obtaining descriptions of transaction data and/or dataset data that is not presented in a dataset. For example, the historical dataset reconciliation data may include metadata, such as transaction type, customer type, customer name, account holder name or identifier (ID), server ID, application data, and types of goods and/or services associated with an event record in a dataset.

The system uses the historical dataset reconciliation data to generate a set of training data (Operation 304). The set of training data includes, for a particular set of dataset reconciliation data including a plurality of event records, at least one classification label. For example, a set of dataset data may include a first set of event records of a first type and a second set of event records of a second type. The first set of event records may be records that are reconciled to the second set of event records. The second set of event records may represent a ground truth set of records. For example, in a financial environment, the second set of financial records may be a general ledger, and the first set may be a sub-ledger that is being reconciled to the general ledger. According to another example, the first set of event records may be records of files transferred from a central repository to a remote repository. The second set of event records may reflect files stored in the remote repository.

In one embodiment, the first and second sets of event records are reconciled event records. For example, the first set of event records may include at least one remediation record. The remediation record includes an attribute value selected to reconcile the first set of event records to the second set of event records. In an alternative embodiment, the first and second sets of event records may be un-reconciled. The first and second sets of event records omit any remediation record. The label represents if auto-reconciliation of the event records is correct. The label may be, for example, a binary value. A “1” may indicate auto-reconciliation is proper. A “0” may indicate auto-reconciliation is improper. According to an alternative embodiment, the label is a value along a continuum. The value may represent a confidence level that reconciliation is proper. For example, the continuum may be from 0 to 1. A higher value along the continuum, such as 0.8 or 0.9, may represent a higher confidence level that auto-reconciliation is proper. A lower value along the continuum, such as 0.2 or 0.3, may represent a lower confidence level that auto-reconciliation is proper.

According to one embodiment, the system obtains the historical data and the training data set from a data repository storing labeled data sets. The training data set may be generated and updated by an event record management system. In an example embodiment in which the event records are financial transactions, the system may be a financial record management system. Alternatively, the training data set may be generated and maintained by a third party. According to one embodiment, the system generates the labeled set of data by parsing documents and generating labels based on parsed values in the documents. According to an alternative embodiment, one or more users generate labels for a data set.

In one or more embodiments, the set of training data is selected to include representative event records for reconciliation rules. In other words, while the system does not expressly describe rules to the machine learning model, the training data set of event records includes examples of application of the rules to train the model to apply the rules. Examples of reconciliation rules include rules based on entities associated with datasets, rules based on magnitudes of attribute values in dataset records, and rules based on patterns over time for datasets associated with an entity. For example, a rule may be structured as follows: for a dataset originating from [Entity], perform auto-reconciliation if (a) a date associated with a discrepancy meets [condition 1], (b) a magnitude associated with the discrepancy meets [condition 2], and a pattern associated with the discrepancy over [number] recording periods meets [condition 3].

An example may include the following: for datasets originating from source ABC Co., perform auto-reconciliation when a discrepancy between a cumulative value for an attribute in a first dataset is less than 100 units from the cumulative value for the attribute in a second dataset; do not perform auto-reconciliation (recommend manual reconciliation) when the discrepancy is 100 units or more. For datasets originating from source DEF Co., perform auto-reconciliation when a discrepancy between a cumulative value for an attribute in a first dataset is less than 200 units from the cumulative value for the attribute in a second dataset; do not perform auto-reconciliation (recommend manual reconciliation) when the discrepancy is 200 units or more.

Another example may include the following: for datasets originating from any source, do not perform auto-reconciliation if more than five (5) discrepancies exist between two datasets in one reporting period.

In an example where datasets store financial data and are maintained by a financial management platform, a rule may allow auto-reconciliation when a total transaction amount variance between a first dataset and a second dataset is less than a threshold (e.g., $100). A system may apply different values for the discrepancy based on a time associated with the datasets. For example, an entity may allow a discrepancy of $100 for three reconciliation periods. The same entity may allow a discrepancy of $10 in a fourth reconciliation period. An entity may allow or disallow auto-reconciliation if a discrepancy is associated with a particular customer, customer type, or transaction type. An entity may allow auto-reconciliation for a particular account while disallowing auto-reconciliation for another account. An entity may determine whether to allow/disallow auto-reconciliation based on additional features including an account balance, a number of transactions in a reconciliation period, and a magnitude of transactions in a reconciliation period. The set of training data is selected to represent a threshold number of examples of sets of auto-reconciliation rules for different entities to allow the time-aware machine learning model to learn relationships between event records data, metadata, and whether to allow/disallow auto-reconciliation.

While the above example describes a financial system, embodiments are not limited to financial systems. For example, reconciliation rules may specify rules for reconciling records of physical objects, such as inventory stored at various locations in a physical inventory network. Locations may include, for example, a manufacturing facility, a warehouse, and a retail establishment. As another example, reconciliation rules may specify rules for reconciling records of digital objects, such as data packets, data files, data objects, and software modules stored in memory in a computing environment.

In one or more embodiments, the training data set includes examples of sets of event records that include labels, such as “auto-reconciled, but erroneous,” “auto-reconciled, no error”, “manually reconciled, erroneous,” and “manually reconciled, no error.” In some cases, an erroneous reconciliation may indicate the reconciliation was erroneous. For example, a value added to a set of event records may have been incorrect. In other examples, an indication of a reconciliation error means that although the reconciliation was correct, the reconciliation type was incorrect. For example, a reconciliation that involves a high level of complexity (such as multiple transactions across multiple reconciliation periods and multiple different entity types) may require manual reconciliation. Accordingly, a record showing an auto-reconciliation of this set of event records may be designated as erroneous even if the auto-reconciliation was performed correctly and did not result in any reconciliation error in the record.

In some embodiments, generating the training data set includes generating a set of feature vectors for the labeled examples. A feature vector for an example may be n-dimensional, where n represents the number of features in the vector. The number of features that are selected may vary. The features may be curated in a supervised approach or automatically selected from extracted attributes during model training and/or tuning. Example features include event record type, attribute amount or magnitude, account type, customer type, owner type, customer or owner identifier (ID), the event record date for event in a set of event records, and the event record set date representing a date when a set of event records was captured (such as a date of account reconciliation). In some embodiments, a feature within a feature vector is represented numerically by one or more bits. The system may convert categorical attributes to numerical representations using an encoding scheme, such as one-hot encoding, label encoding, and/or binary encoding. One-hot encoding creates a unique binary feature for each possible category in an original feature. In one-hot encoding, when one feature has a value of 1, the remaining features have a value of 0. For example, if a type of transaction service has ten different categories, the system may generate ten different features of an input data set. When one category is present (e.g., value “1”), the remaining features are assigned a value “0.” According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the machine learning model (Operation 306). For example, the machine learning algorithm may analyze the training data set to train neurons of a neural network with weights and offsets to associate sets of event records with reconciliation labels. As discussed above, the reconciliation labels indicate whether to auto-reconcile or recommend manual reconciliation for two or more datasets. The reconciliation label may be a binary value or a value along a continuum.

The system iteratively applies the machine learning algorithm to sets of event record data in a set of input data to generate an output set of labels, compares the generated labels to pre-generated labels associated with the input data, adjusts weights and offsets of the algorithm based on an error value, and applies the algorithm to another set of event record data.

In some embodiments, the machine learning model analyzes event record data over time. For example, the machine learning model may be trained to generate an output label based on a present set of input event record data and five previously input sets of input event record data. Examples of the machine learning model that analyzes event record data over time include a recurrent neural network (RNN), a long short-term memory (LSTM) network, a gated recurrent unit (GRU) based network, a temporal convolutional network (TCN), and a transformer-based network.

For example, the machine learning model may be an LSTM model. The LSTM model includes one or more network nodes or “cells” that include a memory. The memory allows individual nodes in the neural network to capture dependencies based on the order in which feature vectors are fed through the model. The weights applied to a feature vector representing one set of event record data may depend on its position within a sequence of feature vector representations. Thus, the nodes may have a memory to remember relevant temporal dependencies between different sets of event records. For example, a set of event records in isolation may have a first set of weights applied by nodes as a function of the respective feature vector for the expense. However, if the set of event record data is immediately preceded by a sequence of auto-reconciled sets of event record data, then a different set of weights may be applied by one or more nodes based on the memory of the preceding set of event record data. In this case, a reimbursement value assigned to the subsequent set of event record data is affected by the preceding set of event record data.

In some embodiments, the system compares the labels estimated through the one or more iterations of the machine learning model algorithm with observed labels to determine an estimation error (Operation 308). The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether or not to adjust the weights and/or other model parameters based on the estimation error (Operation 310). Adjustments may be made until a candidate model that minimizes the estimation error or otherwise achieves a threshold level of estimation error is identified. The process may return to Operation 308 to make adjustments and continue training the machine learning model.

In some embodiments, the system selects machine learning model parameters based on the estimation error meeting a threshold accuracy level (Operation 312). For example, the system may select a set of parameter values for a machine learning model based on determining that the trained model has an accuracy level for predicting labels for medical claims of at least 98%.

In some embodiments, the system trains a neural network using backpropagation. Backpropagation is a process of updating cell states in the neural network based on gradients determined as a function of the estimation error. With backpropagation, nodes are assigned a fraction of the estimated error based on the contribution to the output and adjusted based on the fraction. In recurrent neural networks, time is also factored into the backpropagation process. As previously mentioned, a given example may include a sequence of sets of event records. Each set of event records may be processed as a separate discrete instance of time. For instance, an example may include set of event records r₁, r₂, and r₃, corresponding to times t, t+1, and t+2, respectively. Backpropagation through time may perform adjustments through gradient descent starting at time t+2 and moving backward in time to t+1 and then to t. Furthermore, the backpropagation process may adjust the memory parameters of a cell such that a cell remembers contributions from previous sets of event records in the sequence of sets of event records. For example, a cell computing a contribution for r₃ may have a memory of the contribution of r₂, which has a memory of r₁. The memory may serve as a feedback connection such that the output of a cell at one time (e.g., t) is used as an input to the next time in the sequence (e.g., t+1). The gradient descent techniques may account for these feedback connections such that the contribution of one set of event records to a cell's output may affect the contribution of the next set of event records in the cell's output. Thus, the contribution of r₁ may affect the contribution of r₂, etc.

Additionally, or alternatively, the system may train other types of machine learning models. For example, the system may adjust the boundaries of a hyperplane in a support vector machine or node weights within a decision tree model to minimize estimation error. Once trained, the machine learning model may be used to estimate labels for new examples of sets of event records.

In embodiments in which the machine learning algorithm is a supervised machine learning algorithm, the system may optionally receive feedback on the various aspects of the analysis described above (Operation 314). For example, the feedback may affirm or revise labels generated by the machine learning model. The machine learning model may indicate that a particular set of event records is associated with a label indicating a recommendation score for auto-reconciliation of “0.8”. The system may receive feedback indicating that the recommendation score should instead be set at “0.5”. Based on the feedback, the machine learning training set may be updated, thereby improving its analytical accuracy (Operation 316). Once updated, the system may further train the machine learning model by optionally applying the model to additional training data sets.

One or more embodiments train the time-aware machine learning model to adjust an auto-reconciliation confidence level for subsequent sets of event records based on the success/failure of recommendations for previous sets of event records. For example, a system may be configured to receive feedback regarding whether the time-aware machine learning model's auto-reconciliation confidence level was correct or incorrect. If the machine learning model correctly generates a high or low confidence level for a threshold number of consecutive sets of event records, the system may configure the time-aware model to increase the confidence level associated with high confidence level predictions and decrease the confidence level associated with low confidence level predictions. The system may configure the time-aware model based on retraining the machine learning model. Alternatively, the system may configure the time-aware model based on applying a set of logical rules to the output of the model to increase/decrease the confidence level output by the model.

In an example embodiment, a system trains a time-aware machine learning model, such as an LSTM model, to generate a recommendation score representing a confidence that a first set of financial records should be auto-reconciled with a second set of financial records. The first set of financial records may differ from the second set of financial records based on one or more of the following: omitting one or more event records included in the second set of financial records; including one or more event records omitted from the second set of financial records; including an amount for one or more event records that differs from the amount in the corresponding records of the second set of financial records; including a description for a transaction that differs from the description for the transaction in the second set of financial records; and including a date for a transaction that differs from the date for the transaction in the second set of financial records. The system provides a sequence of sets of financial records to the LSTM model. The sets may include (a) a sub-ledger record for a period of time and (b) a general ledger record for the same period of time. The LSTM model generates a recommendation score representing a confidence that the sub-ledger record for the period of time may be auto-reconciled. If the system determines the recommendation score exceeds a threshold, the system generates a remediation record to include in the sub-ledger record to auto-reconcile the sub-ledger record to the general ledger.

According to another example, the time-aware machine learning model learns, based on the training data set, to generate a different auto-reconciliation recommendation score for the same set of financial record data that occurs at a different period of time or in a different sequence of periods of time. For example, the set of training data may adhere to a rule that if an account is auto-reconciled in three subsequent reconciliation periods, the account should not be auto-reconciled in the fourth subsequent reconciliation period. The time-aware machine learning model analyzes the present set of financial record data in view of the previous sets of financial record data. Accordingly, the time-aware machine learning model generates a low recommendation score for auto-reconciliation of an account based on determining the account was auto-reconciled in the previous three reconciliation periods.

While embodiments are described above

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

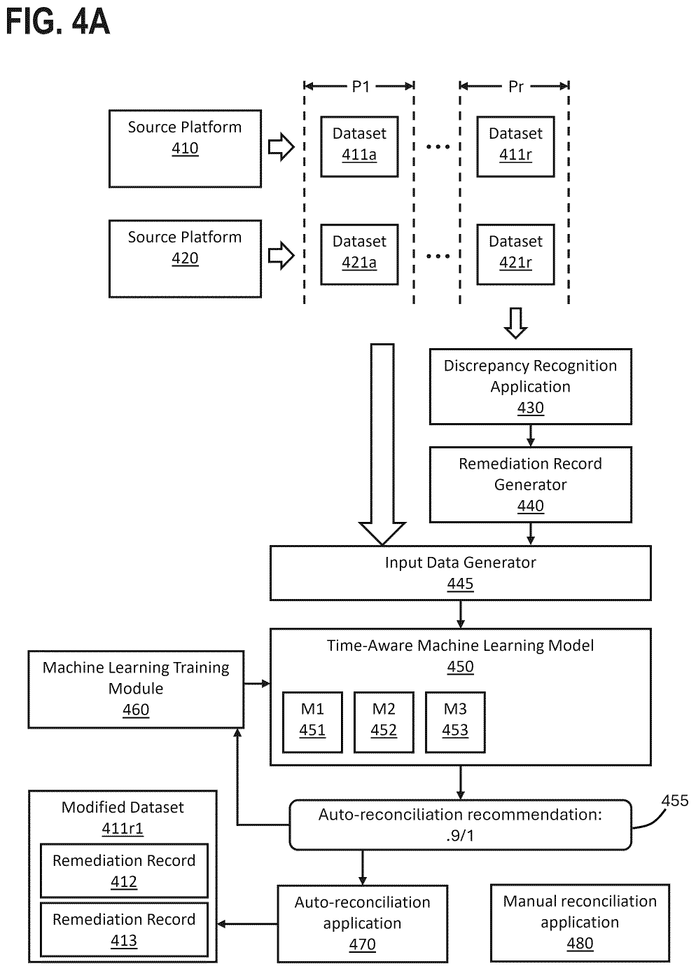

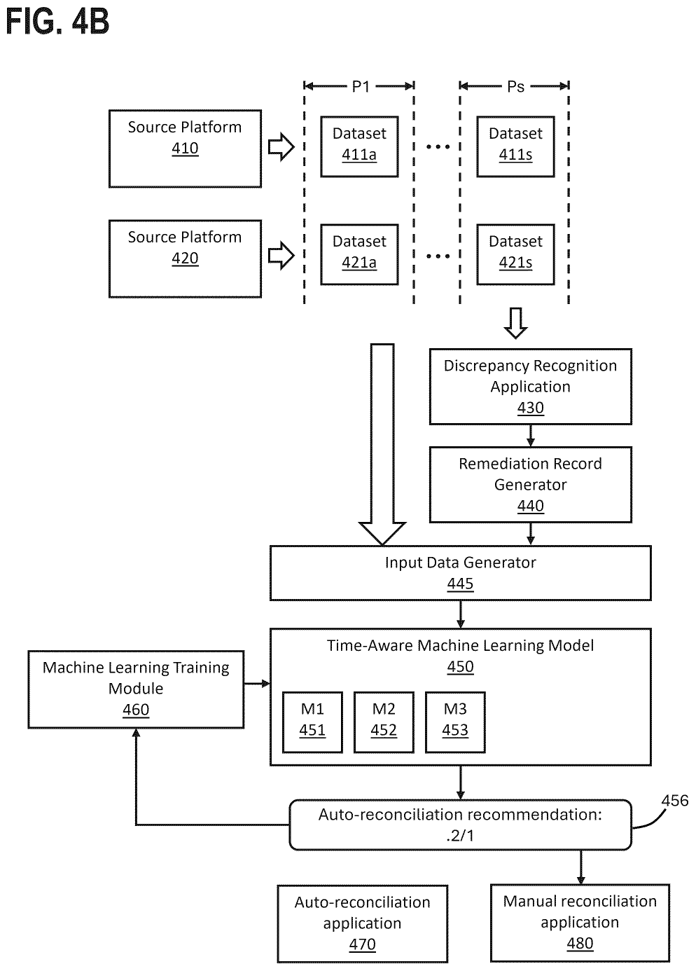

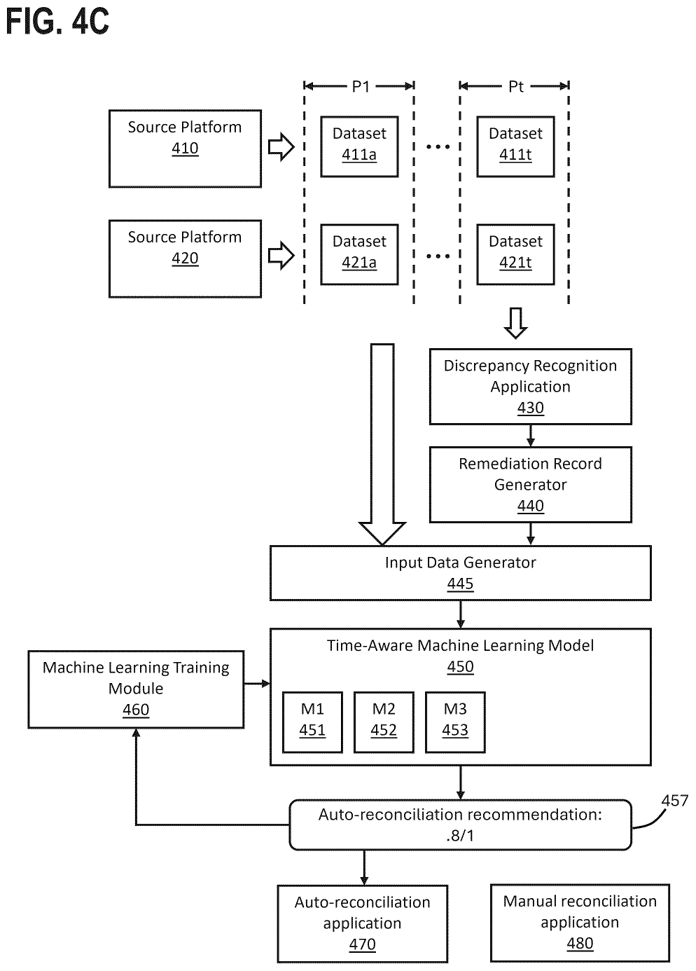

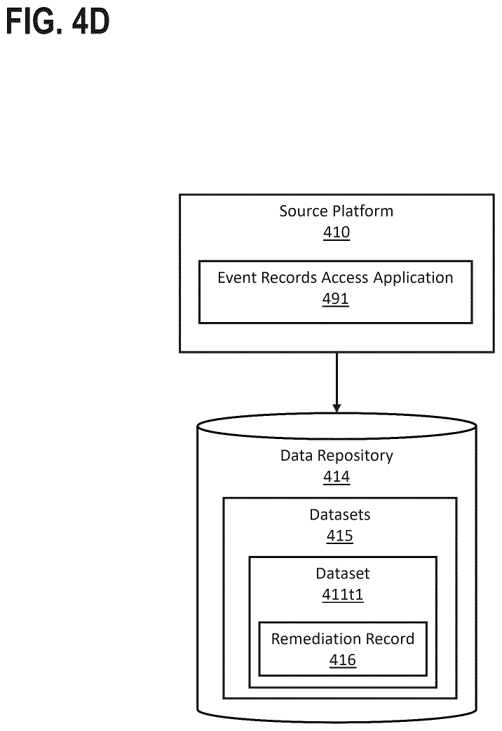

FIGS. 4A-4D illustrate operations for reconciling datasets based on a machine learning recommendation score corresponding to a recommendation to perform an auto-reconciliation or manual reconciliation. A source platform 410 generates datasets of event records 411a-411r. A source platform 420 generates datasets of event records 421a-421r. The datasets correspond to respective periods of time. Datasets 411a and 421a record events during the period of time P1. Datasets 411r and 421r record events during the period of time Pr.

Events include the transaction of currency, goods, and/or data between an entity associated with source platform 410 and an entity associated with source platform 420.

A discrepancy recognition application 430 identifies discrepancies between the dataset 411r and the dataset 421r. In the example embodiment, dataset 411r includes an event record that is not recorded in the dataset 421r. In addition, dataset 421r records a value for an event record that differs from the value recorded for the same event in an event record in dataset 411r.

A remediation record generator 440 generates attribute values for two remediation records. One remediation record includes data for the event that is not recorded in dataset 421r. Another remediation record includes a value based on the difference in attribute values for the same event recorded in datasets 411r and 421r.

The remediation record generator 440 provides to an input data generator 445 one or both of (a) discrepancy data describing the identified discrepancies and (b) the remediation record attributes. In addition, the input data generator 445 obtains datasets 411r and 421r. The input data generator 445 converts dataset data, discrepancy data, and remediation record data into an input vector. The input data generator 445 provides the input vector to the time-aware machine learning model 450.

In the embodiment of FIGS. 4A-4C, the time-aware machine learning model 450 is a transformer-type model. The model includes memory to store previously received input data. Accordingly, the input data generator 445 provides an input vector including data representing datasets 411r and 421r. The memory units M1 451, M2 452, and M3 453 of the machine learning model 450 store data representing previously received datasets 411q, 411p, 4110, 421q, 421p, and 4210.

Based on the input data, including the input vector generated by the input data generator 445 and the data representing the previously received datasets 411q, 411p, 4110, 421q, 421p, and 4210, the time-aware machine learning model 450 generates an auto-reconciliation recommendation score 455 of “0.9”.

Based on the auto-reconciliation recommendation score, an auto-reconciliation application 470 reconciles the datasets 411r and 421r without intervening human input. The auto-reconciliation application 470 inserts a first remediation record into dataset 411r that corresponds to a difference in values between event records in datasets 411r and 421r that represent the same event. The auto-reconciliation application 470 inserts a second remediation record into dataset 411r that corresponds to the event that is recorded in dataset 411r but is not recorded in dataset 421r. For example, the event record may include (a) an attribute value selected to cancel out the attribute value of the event record that is included in dataset 411r but not included in dataset 421r and (b) a categorization that the event record is not yet recorded in the source platform 420 and should be recorded in a subsequent dataset (e.g. dataset 411s). Based on the reconciliation, the auto-reconciliation application 470 generates a modified dataset 411r1 that includes the remediation records 412 and 413. Subsequent to the reconciliation, a user or application requesting access to dataset 411r is provided a modified dataset 411r1 that includes the remediation records 412 and 413. For example, a forecasting-type application may request event records in dataset 411r to generate a forecast of future performance. The modified dataset 411r1 gives the forecasting application a more accurate picture of a sequence of events than the dataset 411r.

Based on the results of the auto-reconciliation of the datasets 411r and 421r, the system provides the auto-reconciliation recommendation score 455 and the datasets 411r and 421r to the machine learning training module 460. The machine learning training module 460 stores the data as training data records to retrain the time-aware machine learning model 450.

In one example embodiment, the datasets represent transactions of data files between data repositories. The auto-reconciliation application 470 generates a first remediation record to include in the dataset 411r that represents an error in a file size associated with a data transfer request. The source platform 410 may analyze the first remediation record to identify the source application that caused the recording error. The auto-reconciliation application 470 generates a second remediation record to include in the dataset 411r that represents a file transfer that was initiated prior to the end of a recording period but that did not conclude before the end of the recording period.

In another example embodiment, the datasets represent financial transactions. The source platform 410 corresponds to a company's ledger. The source platform 420 corresponds to the records of a financial institution. The auto-reconciliation application 470 generates a first remediation record to include in the dataset 411r that represents a discrepancy in an amount associated with a deposit from the company to the financial institution. The source platform 410 may analyze the first remediation record to identify the source application, individual, or check that caused the recording error. The auto-reconciliation application 470 generates a second remediation record to include in the dataset 41 Ir that represents a deposit that was submitted by the company prior to the end of the recording period but that was not processed by the financial institution prior to the end of the recording period. The classification for the remediation record specifies that the transaction should be recorded by the company in a subsequent recording period.

FIG. 4B illustrates a process for determining whether or not to perform auto-reconciliation in a next time period, Ps. The source platform 410 generates a new dataset 411s. The source platform 420 generates a new dataset 421s.

The discrepancy recognition application 430 identifies at least one discrepancy between the dataset 411s and the dataset 421s. The remediation record generator 440 generates attribute values for at least one remediation record to add to dataset 411s. The input data generator 445 generates an input vector based on one or both of (a) discrepancy data describing the identified discrepancies and (b) the remediation record attributes. The input vector further includes values representing datasets 411s and 421s.

Based on the input data, including the input vector generated by the input data generator 445 and the data representing the previously received datasets 411r, 411q, 411p, 421r, 421q, and 421p, the time-aware machine learning model 450 generates an auto-reconciliation recommendation score 456 of “0.2”. In the example illustrated in FIG. 4B, the auto-reconciliation score of 0.2 is based at least in part on a determination by the time-aware machine learning model 450 that manual reconciliation should be performed when the three previous reconciliations were auto-reconciliations. In other words, the time-aware machine learning model 450 learned, via training on datasets of historical reconciliation recommendations, discrepancies, and historical records, that manual reconciliation should be performed when the three previous reconciliations were auto-reconciliations. The time-aware machine learning model 450 detected, based on the stored data representing the historical datasets, that datasets 411r, 411q, and 411p were reconciled via auto-reconciliation. Accordingly, the time-aware machine learning model 450 generated an output recommendation score, 0.2, that corresponds to manual reconciliation.

Based on the auto-reconciliation recommendation score, a user interacts with a manual reconciliation application 480 to reconcile the datasets 411s and 421s. The manual reconciliation application 480 may obtain a suggested remediation record from the remediation record generator 440. Subsequent to the reconciliation, a user or application requesting access to dataset 411s is provided a modified dataset 411s that includes the remediation record.

Based on the results of the manual reconciliation of the datasets 411s and 421s, the system provides the auto-remediation recommendation score 456 and the datasets 411s and 421s to the machine learning training module 460. The machine learning training module 460 stores the data as training data records to retrain the time-aware machine learning model 450.

FIG. 4C illustrates a process for determining whether or not to perform auto-reconciliation in a next time period, Pt. The source platform 410 generates a new dataset 411t. The source platform 420 generates a new dataset 421t.

The discrepancy recognition application 430 identifies at least one discrepancy between the dataset 411t and the dataset 421t. The remediation record generator 440 generates attribute values for at least one remediation record to add to dataset 411t. The input data generator 445 generates an input vector based on one or both of (a) discrepancy data describing the identified discrepancies and (b) the remediation record attributes. The input vector further includes values representing datasets 411t and 421t.

Based on the input data, including the input vector generated by the input data generator 445 and the data representing the previously received datasets 411s, 411r, 411q, 421s, 421r, and 421q, the time-aware machine learning model 450 generates an auto-reconciliation recommendation score 457 of “0.8”.

Based on the auto-reconciliation recommendation score, the auto-reconciliation application 470 automatically reconciles the datasets 411t and 421t without human intervention. The auto-reconciliation application 470 inserts at least one remediation record into the dataset 411t to reconcile the datasets 411t and 421t. Subsequent to the reconciliation, a user or application requesting access to dataset 411t is provided a modified dataset 411t that includes the remediation record.

Based on the results of the auto-reconciliation of the datasets 411t and 421t, the system provides the auto-reconciliation recommendation score 457 and the datasets 411t and 421t to the machine learning training module 460. The machine learning training module 460 stores the data as training data records to retrain the time-aware machine learning model 450.

As illustrated in FIG. 4D, the source platform 410 may include an event records access application 491. For example, an application 491 may select sets of event records to display in a graphical user interface to generate metrics for graphs and reports for prognostication applications or to determine resource allocation. The system stores datasets 415 in a data repository 414. The datasets 415 may include, for example, datasets 411a-411t. When an application 491 requests a set of event records associated with dataset 411t, the source platform 410 retrieves a modified dataset 411t1 that includes a remediation record 416. The event records access application 491 may perform data analysis, display, and prognostication functions on the modified dataset 411t1 instead of the initial dataset 411t.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

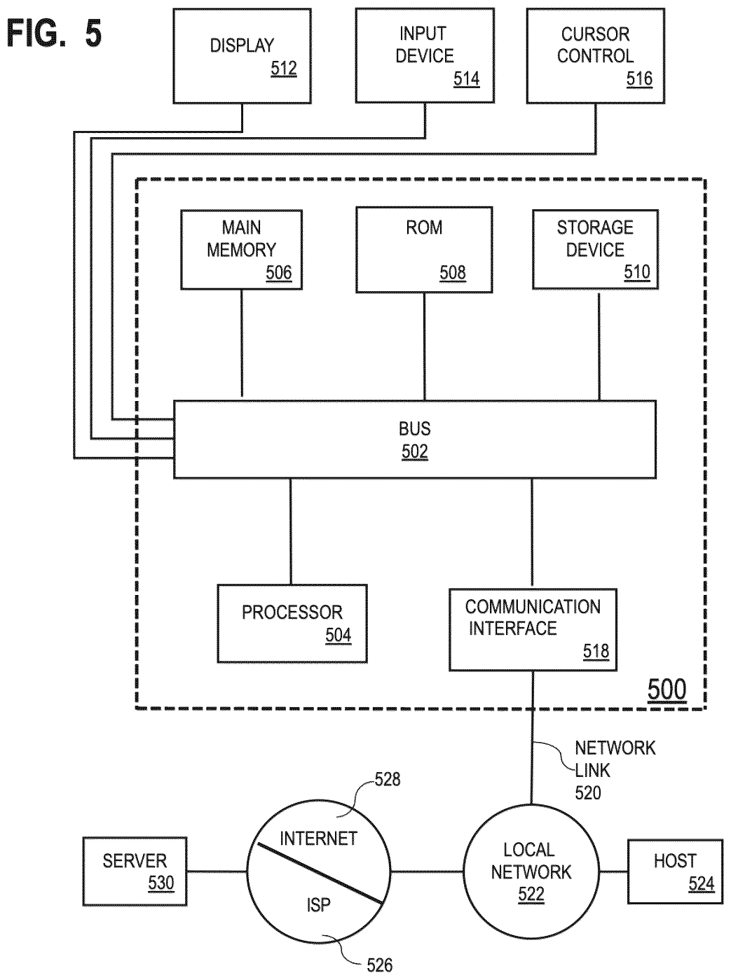

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
obtaining training datasets of historical data, the training datasets comprising:
discrepancies between historical datasets of event records; and
labels specifying one of: an auto-reconciliation process performed without human intervention or a manual reconciliation process performed by a human for remediating the discrepancies between the historical datasets of event records;
training a machine learning model to determine whether to perform (a) auto-reconciliation operations, without human intervention, to remediate discrepancies between datasets or (b) manual remediation operations, with human intervention, to remediate the discrepancies between the datasets;
obtaining a target pair of datasets comprising:
a first dataset comprising a first set of event records; and
a second dataset comprising a second set of event records;
analyzing the first set of event records and the second set of event records to identify a first discrepancy between the first set of event records and the second set of event records; and
applying the machine learning model to the first discrepancy to generate a first selection to perform an auto-reconciliation operation, without human intervention, to remediate the first discrepancy.

2. The one or more non-transitory computer readable media of claim 1, wherein training the machine learning model to determine whether to perform auto-reconciliation operations or a manual reconciliation process comprises:
training the machine learning model to generate recommendation scores, the recommendation scores to be used for determining whether to perform (a) the auto-reconciliation operations or (b) the manual remediation operations to remediate the discrepancies between the datasets.

3. The one or more non-transitory computer readable media of claim 2, wherein the first selection to perform the auto-reconciliation operation is based on a first recommendation score generated by the machine learning model.

4. The one or more non-transitory computer readable media of claim 3, wherein the training datasets of historical data are divided into time periods,
wherein the training datasets of historical data exemplify rules for performing auto-reconciliation and manual reconciliation to reconcile discrepancies between datasets, and
wherein training the machine learning model comprises:
based on the training datasets, training the machine learning model to generate the first recommendation score based on determining auto-reconciliation was performed in a first number of preceding time periods less than a second threshold number; and
training the machine learning model to generate a second recommendation score, lower than the first recommendation score, based on determining the auto-reconciliation was performed in a second number of preceding time periods equal to, or greater than, the second threshold number,
wherein the second recommendation score corresponds to a recommendation to perform manual reconciliation.

5. The one or more non-transitory computer readable media of claim 3, wherein the operations further comprise:
executing a selection process that selects the auto-reconciliation operation based on the first recommendation score; and
executing the auto-reconciliation operation to resolve the first discrepancy.

6. The one or more non-transitory computer readable media of claim 1, wherein the operations further comprise:
analyzing a third set of event records and fourth set of event records to identify a second discrepancy between the third set of event records and the fourth set of event records;
applying the machine learning model to the second discrepancy to generate a second selection to perform a manual reconciliation operation to remediate the second discrepancy; and
presenting a recommendation for a user to execute the manual reconciliation operation to resolve the second discrepancy.

7. The one or more non-transitory computer readable media of claim 1, wherein the operations further comprise:
generating a first remediation record, without human intervention, based on the first selection; and
modifying the second set of event records to generate a third set of event records by adding the first remediation record to the second set of event records.

8. The one or more non-transitory computer readable media of claim 7, wherein the first set of event records specifies a first set of attributes corresponding to a first set of events,
wherein the second set of event records specifies a second set of attributes corresponding to a second set of events,
wherein the second set of events includes one or more events from among the first set of events,
wherein the operations further comprise:
receiving a request to access a target set of records corresponding to the second set of events; and
responsive to receiving the request to access the target set of records corresponding to the second set of events: returning the third set of event records including the first remediation record.

9. The one or more non-transitory computer readable media of claim 1, wherein the training datasets of historical data exemplify rules for performing auto-reconciliation and manual reconciliation to reconcile discrepancies between datasets, and
wherein the rules comprise rules for selecting auto-reconciliation or manual reconciliation based on:
a type of event corresponding to the first discrepancy;
a number of discrepancies identified in a time period represented in the second dataset;
a number of auto-reconciliations performed over a plurality of time periods represented in a plurality of datasets preceding the second dataset; and
a magnitude of the first discrepancy.

10. The one or more non-transitory computer readable media of claim 1, wherein the training datasets of historical data exemplify rules for performing auto-reconciliation and manual reconciliation to reconcile discrepancies between datasets, and
wherein the rules comprise rules for selecting auto-reconciliation or manual reconciliation based on a first reliability of the first dataset and a second reliability of the second dataset.

11. The one or more non-transitory computer readable media of claim 1, wherein the machine learning model comprises a memory component to store a set of values representing whether a reconciliation of a discrepancy in a previous time period was an auto-reconciliation or a manual reconciliation,
wherein applying the machine learning model to data representing the first discrepancy to generate a first recommendation score comprises:
generating a first set of vector values representing the first discrepancy identified in a first time period; and
generating a second set of vector values representing (a) a second discrepancy identified in a second time period preceding the first time period and (b) whether a reconciliation operation to remediate the first discrepancy was auto-reconciliation or manual reconciliation, and
wherein the machine learning model generates the first selection corresponding to remediating the first discrepancy based on the first set of vector values and the second set of vector values.

12. The one or more non-transitory computer readable media of claim 1, wherein identifying the first discrepancy between the first set of event records and the second set of event records comprises:
determining a first cumulative attribute value for a first attribute of the first set of attributes of the first set of event records;
determining a second cumulative attribute value for the first attribute of the second set of attributes of the second set of event records; and
determining the first cumulative attribute values is unequal to the second cumulative attribute value.

13. The one or more non-transitory computer readable media of claim 1, wherein resolving the first discrepancy improves consistency between the first dataset and the second dataset.

14. A method comprising:
obtaining training datasets of historical data, the training datasets comprising:
discrepancies between historical datasets of event records; and
labels specifying one of: an auto-reconciliation process performed without human intervention or a manual reconciliation process performed by a human for remediating the discrepancies between the historical datasets of event records;
training a machine learning model to determine whether to perform (a) auto-reconciliation operations, without human intervention, to remediate discrepancies between datasets or (b) manual remediation operations, with human intervention, to remediate the discrepancies between the datasets;
obtaining a target pair of datasets comprising:
a first dataset comprising a first set of event records; and
a second dataset comprising a second set of event records;
analyzing the first set of event records and the second set of event records to identify a first discrepancy between the first set of event records and the second set of event records; and
applying the machine learning model to the first discrepancy to generate a first selection to perform an auto-reconciliation operation, without human intervention, to remediate the first discrepancy,
wherein the method is performed by at least one device including a hardware processor.

15. The method of claim 14, wherein training the machine learning model to determine whether to perform auto-reconciliation operations or a manual reconciliation process comprises:
training the machine learning model to generate recommendation scores, the recommendation scores to be used for determining whether to perform (a) the auto-reconciliation operations or (b) the manual remediation operations to remediate the discrepancies between the datasets.

16. The method of claim 15, wherein the first selection to perform the auto-reconciliation operation is based on a first recommendation score generated by the machine learning model.

17. The method of claim 16, wherein the training datasets of historical data are divided into time periods,
wherein the training datasets of historical data exemplify rules for performing auto-reconciliation and manual reconciliation to reconcile discrepancies between datasets, and
wherein training the machine learning model comprises:
based on the training datasets, training the machine learning model to generate the first recommendation score based on determining auto-reconciliation was performed in a first number of preceding time periods less than a second threshold number; and
training the machine learning model to generate a second recommendation score, lower than the first recommendation score, based on determining the auto-reconciliation was performed in a second number of preceding time periods equal to, or greater than, the second threshold number,
wherein the second recommendation score corresponds to a recommendation to perform manual reconciliation.

18. The method of claim 16, further comprising:
executing a selection process that selects the auto-reconciliation operation based on the first recommendation score; and
executing the auto-reconciliation operation to resolve the first discrepancy.

19. The method of claim 14, further comprising:
analyzing a third set of event records and fourth set of event records to identify a second discrepancy between the third set of event records and the fourth set of event records;
applying the machine learning model to the second discrepancy to generate a second selection to perform a manual reconciliation operation to remediate the second discrepancy; and
presenting a recommendation for a user to execute the manual reconciliation operation to resolve the second discrepancy.

20. A system comprising:
at least one device including a hardware processor;
the system being configured to perform operations comprising:
obtaining training datasets of historical data, the training datasets comprising:
discrepancies between historical datasets of event records; and
labels specifying one of: an auto-reconciliation process performed without human intervention or a manual reconciliation process performed by a human for remediating the discrepancies between the historical datasets of event records;
training a machine learning model to determine whether to perform (a) auto-reconciliation operations, without human intervention, to remediate discrepancies between datasets or (b) manual remediation operations, with human intervention, to remediate the discrepancies between the datasets;
obtaining a target pair of datasets comprising:
a first dataset comprising a first set of event records; and
a second dataset comprising a second set of event records;
analyzing the first set of event records and the second set of event records to identify a first discrepancy between the first set of event records and the second set of event records; and
applying the machine learning model to the first discrepancy to generate a first selection to perform an auto-reconciliation operation, without human intervention, to remediate the first discrepancy.
